(19) United States
(12) Patent Application Publication
(10) Pub. No.: US 2025/0339988 A1
(43) Pub. Date: Nov. 6, 2025

(54) Cutting Apparatus for Performing Linear Cuts of the Oblique or Vertical Type at Least on a Block of Polymeric Material

(71) Applicant: Italian Cutting Systems Societa' A Responsibilita' Limitata, Gravina In Puglia (IT)

(72) Inventor: Fedele Marchetti, Gravina In Puglia (IT)

(21) Appl. No.: 19/197,128

(22) Filed: May 2, 2025

(30) Foreign Application Priority Data
May 3, 2024 (IT) 102024000009922

(51) Int. Cl. B26D 1/30; B26D 1/46; B26D 7/20

(52) U.S. Cl. CPC B26D 1/30; B26D 1/46; B26D 7/20

(57) ABSTRACT

A cutting apparatus for performing linear cuts of the oblique or vertical type at least on a block of polymeric material includes: a worktable that supports the block to be cut; and a carrier member for a cutting tool designed to cut the block. The carrier member defines a cutting axis for the cutting tool. The carrier member can be tilted with respect to the worktable. At least one of the worktable and the carrier member is movable along a movement direction which is arranged angularly with respect to the cutting axis, so as to vary a distance between the worktable and the cutting axis along the movement direction. At least one of the worktable and the carrier member is movable along a cutting direction perpendicular to both the cutting axis and the movement direction.

### CROSS-REFERENCE TO RELATED APPLICATIONS

This application claims priority to and the benefit of Italian Patent Application No. 102024000009922 filed May 3, 2024, the disclosure of which is incorporated herein by reference in its entirety.

### FIELD OF THE DISCLOSURE

The present disclosure relates to a cutting apparatus for performing linear cuts of the oblique or vertical type at least on a block of polymeric material.

### BACKGROUND

The cutting apparatus according to the present disclosure is particularly, but not exclusively, useful and practical for cutting blocks of polymeric material, in particular of polyurethane foam. For example, the cutting apparatus according to the disclosure can be used to bevel blocks like the ones cited above and/or to produce flat sheets of various thicknesses from said blocks.

As is known, performing an oblique or vertical cut on blocks like the ones discussed above is a delicate operation that requires special technical measures.

Typically, known apparatuses for performing this type of cut comprise a worktable, adapted to support the block to be cut, and a carrier member, configured to carry an appropriate cutting tool. Usually, the cutting tool is a blade (for example, a band blade). The blade is conveniently inclined with respect to the worktable so as to affect the block to be cut along an inclined cutting axis. The cut is performed by translating the blade with respect to the block so as to pass through it.

However, known cutting apparatuses for performing linear cuts of the oblique or vertical type are far from optimized. Therefore, further contributions are needed in this technological field.

### SUMMARY

The aim of the present disclosure is to overcome the limitations and drawbacks of the background art, optimizing the execution of linear cuts of the oblique or vertical type on blocks such as those discussed above.

Within this aim, an object of the present disclosure is to obtain more precise linear cuts of the oblique or vertical type than those obtainable with known cutting apparatuses.

Another object of the present disclosure is to devise a cutting apparatus that is more versatile, capable of using a wide range of cutting geometries, in particular from bevels of different sizes and types to flat sheets of various thicknesses.

A further object of the present disclosure is to increase the safety of an operator assigned to cutting (in short: “operator”) under any cutting condition.

A further object of the present disclosure is to conceive a cutting apparatus that is capable of automatically adjusting a cutting setup on the basis of the entry of a few simple input data.

A further object of the present disclosure is to devise a cutting apparatus that has a high degree of modularity. In this context, the present disclosure seeks to reconcile an inline production logic with one or more of the aim and objects discussed above.

Not the least object of the present disclosure is to provide a cutting apparatus that is highly reliable, relatively simple to provide, and economically competitive if compared with the background art.

This aim, as well as these and other objects that will become more apparent hereinafter, are achieved by a cutting apparatus according to claim 1.

The intended aim and objects are also achieved by the dependent claims.

### BRIEF DESCRIPTION OF THE DRAWINGS

Further characteristics and advantages of the present disclosure will become more apparent from the description of a preferred but not exclusive aspect of the cutting apparatus according to the disclosure, illustrated by way of non-limiting example in the accompanying drawings, wherein:

FIG. 1 is a schematic view of a cutting apparatus according to the present disclosure;

FIGS. 2 to 4 are three schematic views of three respective adjustments of a cutting apparatus according to the present disclosure;

FIG. 5 is a side view of a cutting apparatus according to the present disclosure;

FIGS. 6 to 8 are, respectively, a front view (FIG. 6), a top view (FIG. 7) and a perspective view (FIG. 8) of the cutting apparatus of FIG. 5;

FIG. 9 is a schematic view of a cutting operation performed by using the cutting apparatus of FIG. 2;

FIG. 10 is a schematic view of a cutting operation performed by using a particularly advanced aspect of the cutting apparatus of FIG. 5; and

FIG. 11 is a detail view of FIG. 10.

### DETAILED DESCRIPTION

In the description of the preferred and illustrated aspects, identical elements belonging to the same structure or functional group are designated by a reference numeral having the same numerical part.

With reference to the figures, each cutting apparatus according to the present disclosure, generally designated by the reference numeral 10, comprises a worktable 12 and a carrier member 14.

The worktable 12 is adapted to support a block 90 to be cut.

In particular, the block 90 is a block of material such as the ones described above.

In the preferred and illustrated aspects, the block 90 has a rectangular profile, with a base Bw and a height Hw.

The carrier member 14 is configured to carry a cutting tool 16.

Preferably, the cutting tool 16 has a linear extension.

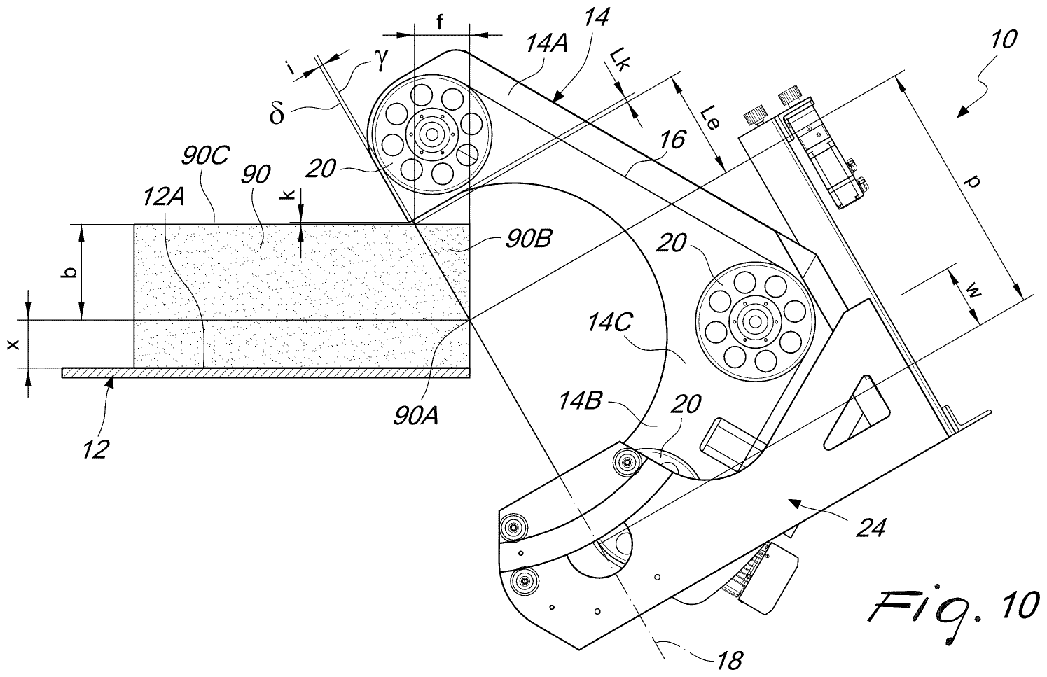

In some preferred aspects, the cutting tool 16 is a blade. For example, in FIG. 10 the cutting tool 16 is a band (or wire) blade. However, alternative aspects are also conceivable in which the cutting tool 16 is another type of blade or, more generally, another cutting tool.

In the preferred aspects that comprise the blade, the carrier member 14 constitutes a blade holder.

In particular, the carrier member 14 is designed to support the blade by virtue of suitable supporting means such as, for example, the pulleys (or flywheels) 20 shown in FIG. 10.

The cutting tool 16 is designed to cut the block 90.

Preferably, the cutting tool 16 is integrated into the carrier member 14. However, alternative aspects are also conceivable in which the cutting tool 16 is a component that is separate from the carrier member 14. In these alternative aspects, the coupling between the cutting tool 16 and the carrier member 14 is performed manually by the operator before the cutting operation 10.

In each aspect, the carrier member 14 forms a cutting axis 18 for the cutting tool 16.

More precisely, the carrier member 14 is designed so that when the carrier member 14 carries the cutting tool 16, at least part of the cutting tool 16 extends along the cutting axis 18.

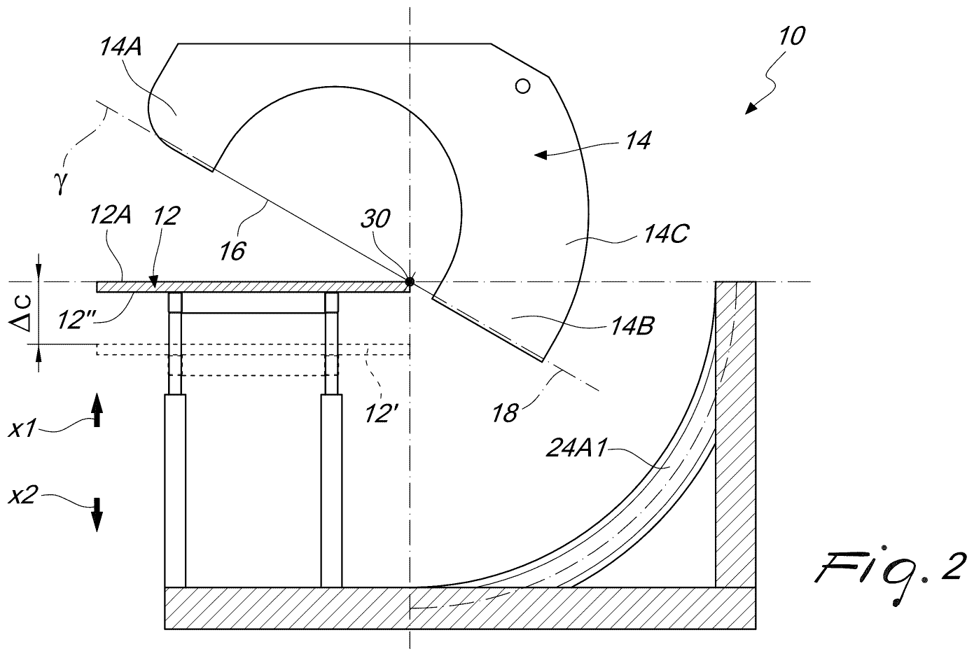

In practice, when the carrier member 14 carries the cutting tool 16, at least one part of the cutting tool 16 (in particular: a useful portion 16U, usable to perform the cut) lies along the cutting axis 18, for example in the way shown by FIGS. 2, 5, 9 and 10.

In the preferred and illustrated aspects, the carrier member 14 is contoured in the shape of an arc, i.e., in a C-shape. However, alternative aspects are also conceivable (but not shown) in which the carrier member 14 assumes alternative shapes (for example, H-like ones).

Preferably, the carrier member 14 comprises an outer casing 14C, which acts as a covering and/or protective element for one or more internal components of said carrier member 14.

In the preferred and illustrated aspects, the carrier member 14 comprises a first end portion 14A and a second end portion 14B (i.e., two portions that give the carrier member 14 an arc-like or C-like shape).

In particular, the two end portions 14A and 14B are arranged so that they are both crossed by the cutting axis 18.

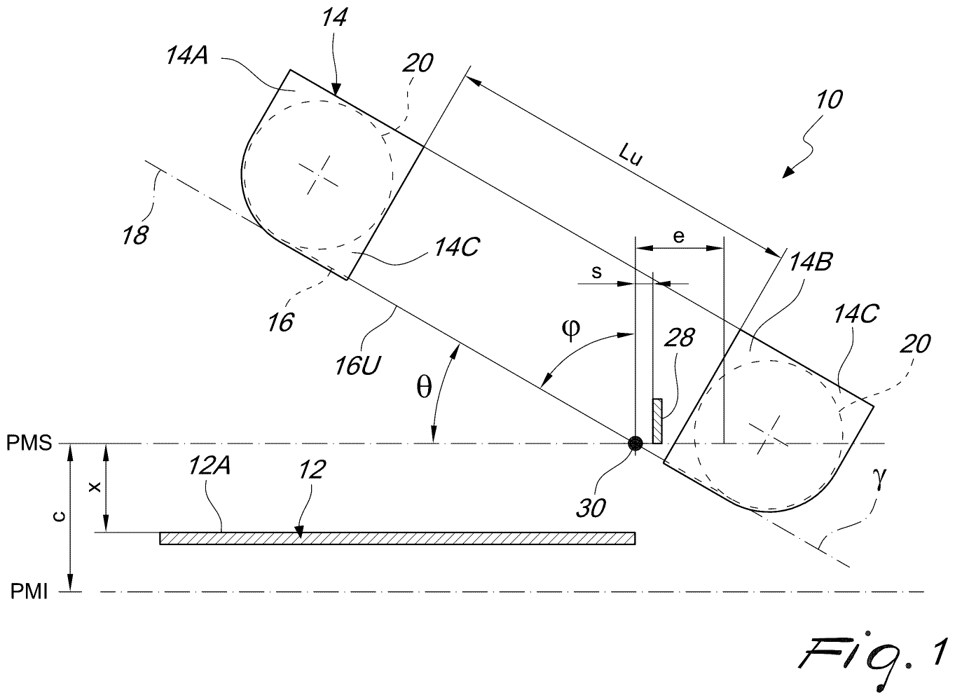

In some preferred aspects, the first end portion 14A and the second end portion 14B form two respective arms of the outer casing 14C (see for example FIGS. 1, 5 and 10).

In each aspect, the carrier member 14 can be tilted with respect to the worktable 12, so as to vary an angle of inclination θ of the cutting axis with respect to the worktable 12.

In particular, the carrier member 14 can be tilted between an operating position in which said angle of inclination θ assumes a first value and an operating position in which the angle of inclination θ assumes a second value, different from the first value.

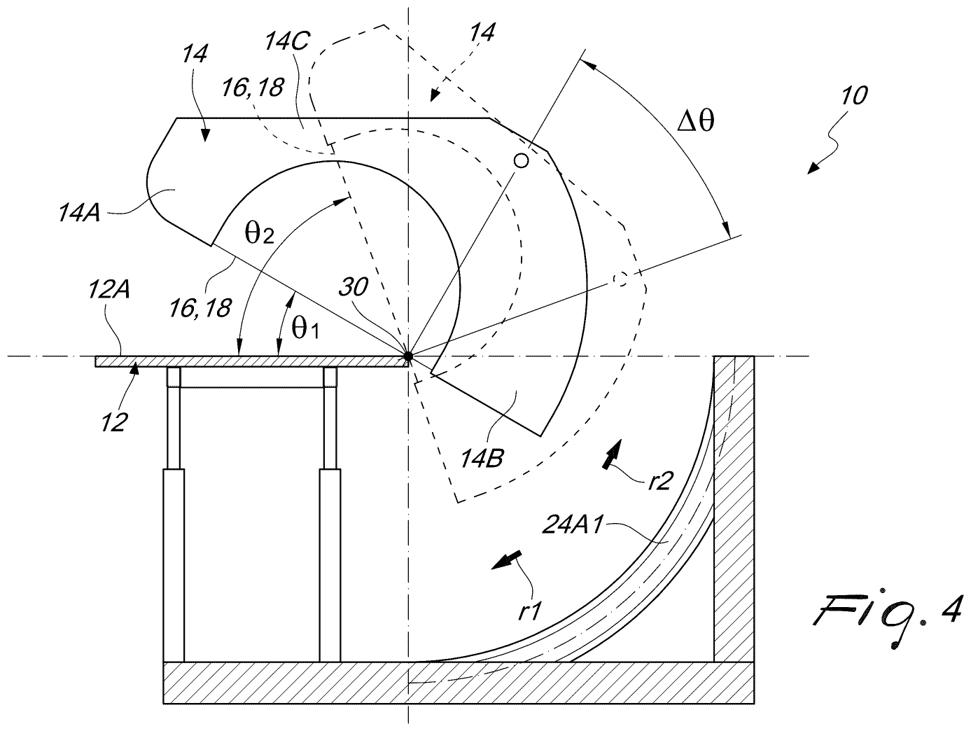

For example, in FIG. 4, a variation Δθ identifies a variation of the angle θ that can be obtained either by rotating the carrier member 14 in the direction indicated by the arrow r1 (i.e., from an operating position in which the angle of inclination θ assumes a value θ1 to an operating position in which the angle of inclination θ assumes a value θ2), or vice versa (i.e., by rotating the carrier member 14 in the direction indicated by the arrow r2, from the operating position in which the angle of inclination θ assumes the value θ2 to the operating position in which the angle of inclination θ assumes the value θ1).

In some preferred aspects, the carrier member 14 is of the tilting type.

In particular, the carrier member 14 is configured to rotate about an axis of rotation 30.

Preferably, the axis of rotation 30 is positioned so that at the end of the cutting of the block 90 said axis of rotation 30 coincides with a lower edge 90A of a beveled portion (or, more generally, of a sectioned portion) of said block 90.

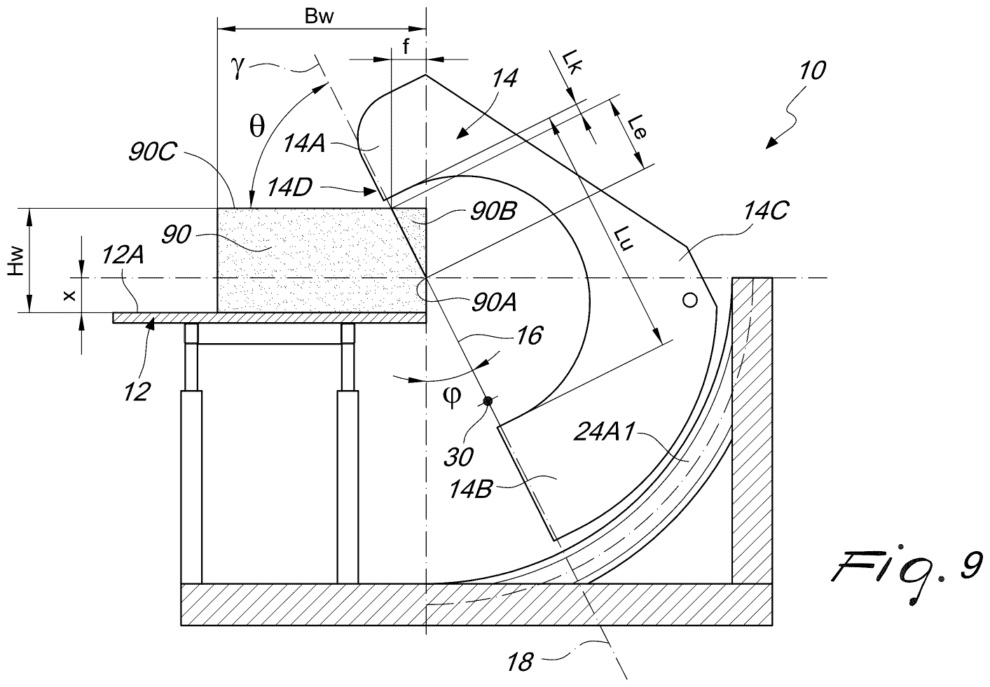

In practice, during a cutting operation, the axis of rotation 30 can be at a so-called “stop” (or base) of a piece of scrap 90B, where “scrap” means a portion of material that is to be cut, and therefore removed, from the rest of the block 90. Consequently, at the end of the cut, the lower edge 90A is positioned at a distance x with respect to an upper surface 12A of the worktable 12, as shown for example by FIGS. 9 and 10.

Advantageously, the carrier member 14 is translatable along the cutting axis 18, so as to vary an axial position w of said carrier member 14 along the cutting axis 18.

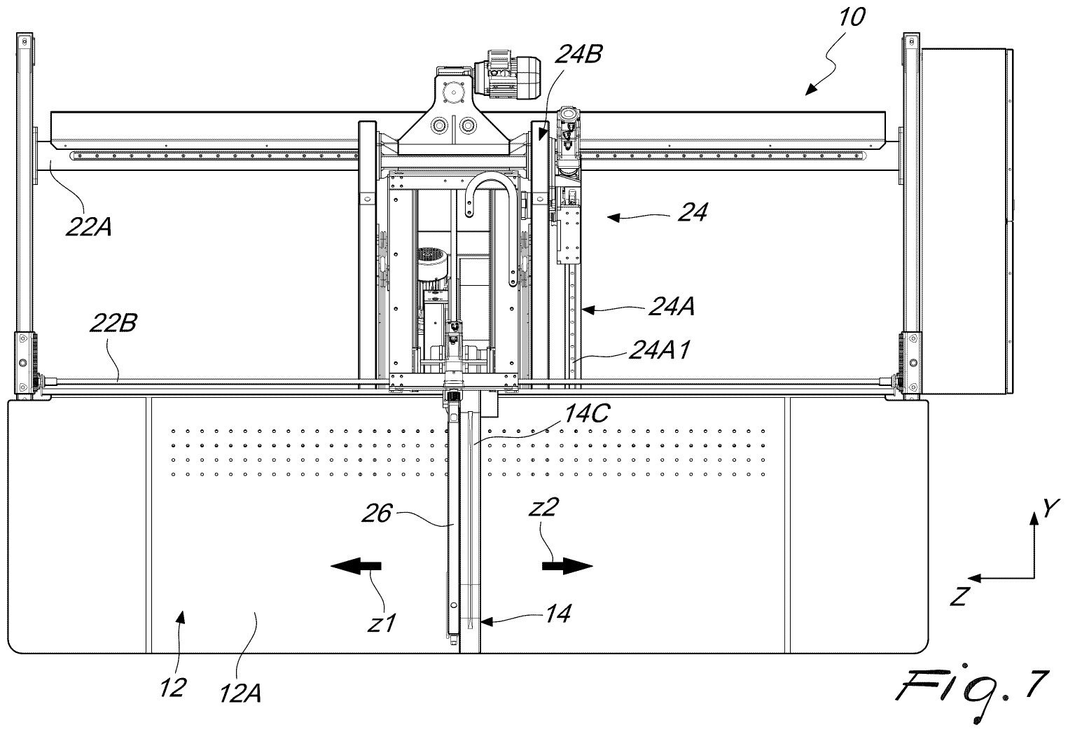

In particular, the cutting apparatus 10 comprises a linear guide 26 (see for example FIG. 7), and the carrier member 14 is configured to slide back and forth, in a selective manner, along the linear guide 26.

In practice, the carrier member 14 can be translated between an operating position in which said axial position w assumes a first value and an operating position in which said axial position w assumes a second value, different from the first value.

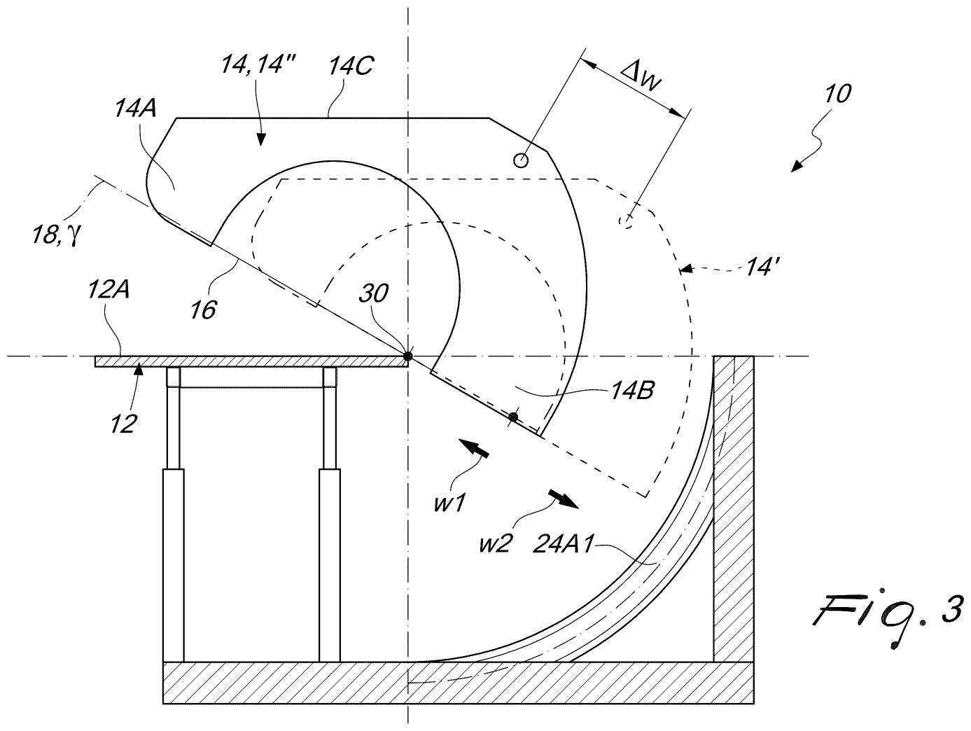

For example, in FIG. 3, Δw identifies a variation in the axial position w obtainable by translating the carrier member 14 in the direction indicated by the arrow w1 (that is, from an operating position shown by means of a dashed-line profile 14′ to an operating position shown by a solid-line profile 14″), or vice versa (i.e., by translating the carrier member 14 in the direction indicated by the arrow w2, from the operating position shown by the solid-line profile 14″ to the operating position shown by the dashed-line profile 14′).

The axial position w of the carrier member 14 can vary within the limits of a maximum range p (see, for example, FIG. 10).

The possibility of translating the carrier member 14 along the cutting axis 18 (i.e., along a directrix of the cutting tool 16) is particularly advantageous when the carrier member 14 is of the tilting type. In this way, it is possible to obtain a tilting structure, which can be oriented safely according to a specific cutting geometry to be obtained.

In some preferred aspects, the cutting apparatus 10 furthermore comprises a retractable side 28 (see for example FIG. 1).

When the cutting apparatus 10 is in manual mode, the retractable side 28 can be moved selectively away from or towards the axis of rotation 30.

In particular, the retractable side 28 can be moved within the limits of a maximum range and according to an adjustment displacement s (see, for example, FIG. 1).

In each aspect, at least one of the worktable 12 and the carrier member 14 can be moved along a movement direction that is arranged angularly with respect to the cutting axis 18, so as to vary a distance between the worktable 12 and the cutting axis 18 along this same movement direction.

In the preferred and illustrated aspects, the movement direction corresponds to any of the directions indicated by the arrows x1 and x2 (see FIG. 2), while the distance between the worktable 12 and the cutting axis 18 (measured along this same movement direction) corresponds to the distance x mentioned above (see FIGS. 1, 9 and 10).

In particular, the movement direction x1, x2 is a vertical direction.

In practice, the distance x corresponds to the height of a so-called “shoulder” of the block 90, that is, of that part of the material (underlying the “stop”) designed to remain in the block 90 even after the cutting operation.

The possibility of moving the worktable 12 and the carrier member 14 mutually apart along the movement direction x1, x2 is particularly (but not exclusively) useful and practical for increasing operator safety at the end of the cutting operation, since it allows to move the part of block 90 that contains said shoulder away from the carrier member 14 without exposing the operator to the cutting tool 16.

In some preferred aspects, the worktable 12 can be moved with respect to the carrier member 14 along the movement direction x1, x2. In other words, the worktable 12 can be adjusted in height (in particular, upward and/or downward).

In the preferred and illustrated aspects, the worktable 12 is configured to move, according to a stroke c, between a lower dead center PMI and an upper dead center PMS.

For example, in FIG. 2, Δc identifies a change in height of the worktable 12. This change in height can be obtained either by moving the worktable 12 in the direction indicated by the arrow x1 (i.e., from an operating position shown by a dashed-line profile 12′ to an operating position shown by a solid-line profile 12″), or by moving the worktable 12 in the direction indicated by the arrow x2 (i.e., from the operating position shown by the solid-line profile 12″ to the operating position shown by the dashed-line profile 12′).

In practice, raising/lowering the worktable 12 determines the height of the shoulder of the block 90 to be beveled/cut. In other words, in the preferred and illustrated aspects, the distance x coincides with the height of the portion of the block 90 that is not affected by the bevel/cut (see for example FIG. 9).

In addition or alternatively, the carrier member 14 can be moved with respect to the worktable 12 along the movement direction x1, x2.

In practice, in particularly advanced aspects the carrier member 14 also can be adjusted in height.

In each aspect, at least one of the worktable 12 and the carrier member 14 can be moved along a cutting direction which is perpendicular to both the cutting axis 18 and the movement direction x1, x2, in order to cut the block 90 along a cutting plane γ on which the cutting axis 18 lies.

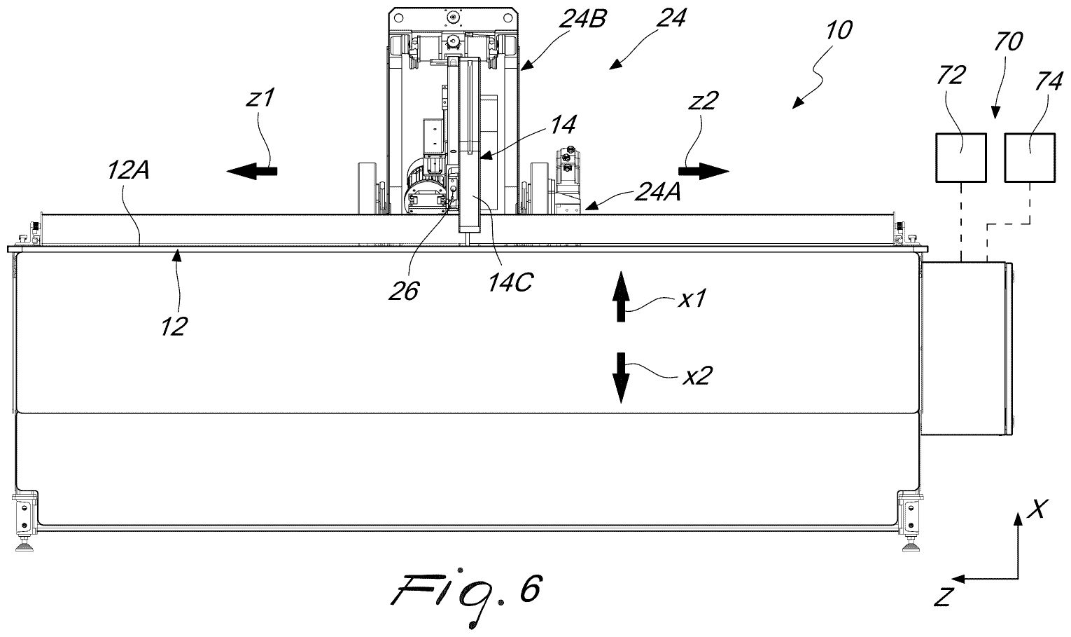

In the preferred and illustrated aspects, the cutting direction corresponds to any of the directions indicated by the arrows z1 and z2 (see FIGS. 6 and 7).

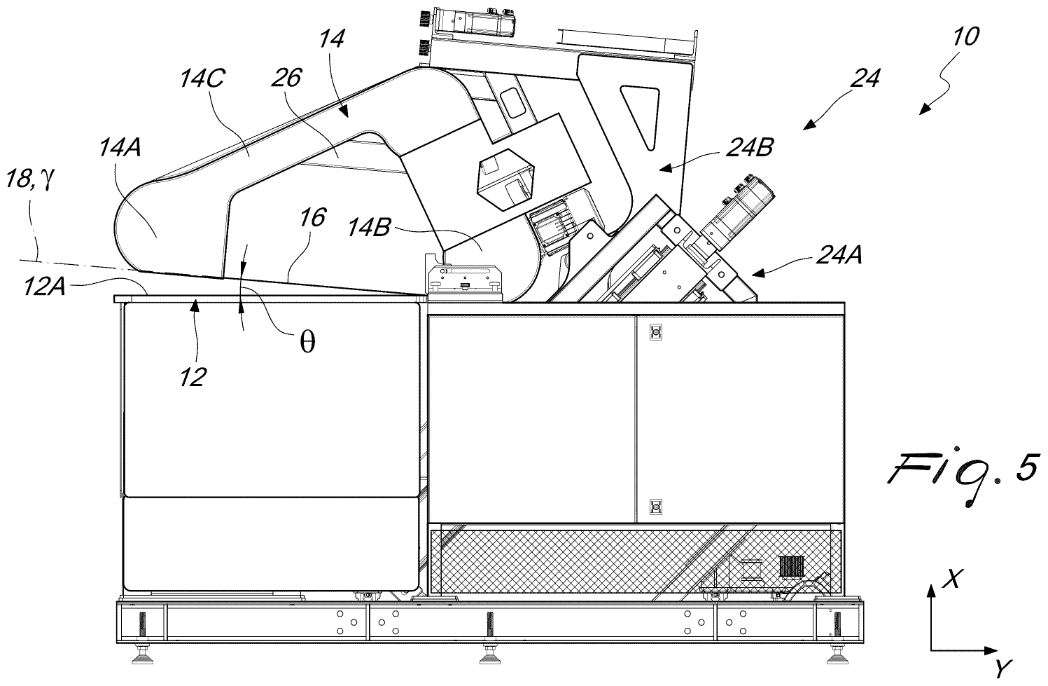

In practice, with reference to a set of three Cartesian axes X, Y and Z like those shown in FIGS. 5 to 8:
the movement direction x1, x2 is either parallel to or coincident with the X axis;
the angle of inclination θ lies on a plane which is parallel to or coincides with the one formed by the X and Y axes; and
the cutting direction z1, z2 is parallel to or coincides with the Z axis.

In particularly advanced preferred aspects (which are however not shown), at least part of the worktable 12 (in particular: at least the upper surface 12A) is further movable along the cutting direction z1, z2. For example, the worktable may comprise a conveyor belt (which forms the upper surface 12A) adapted to move the block 90 to be cut along the cutting direction z1, z2.

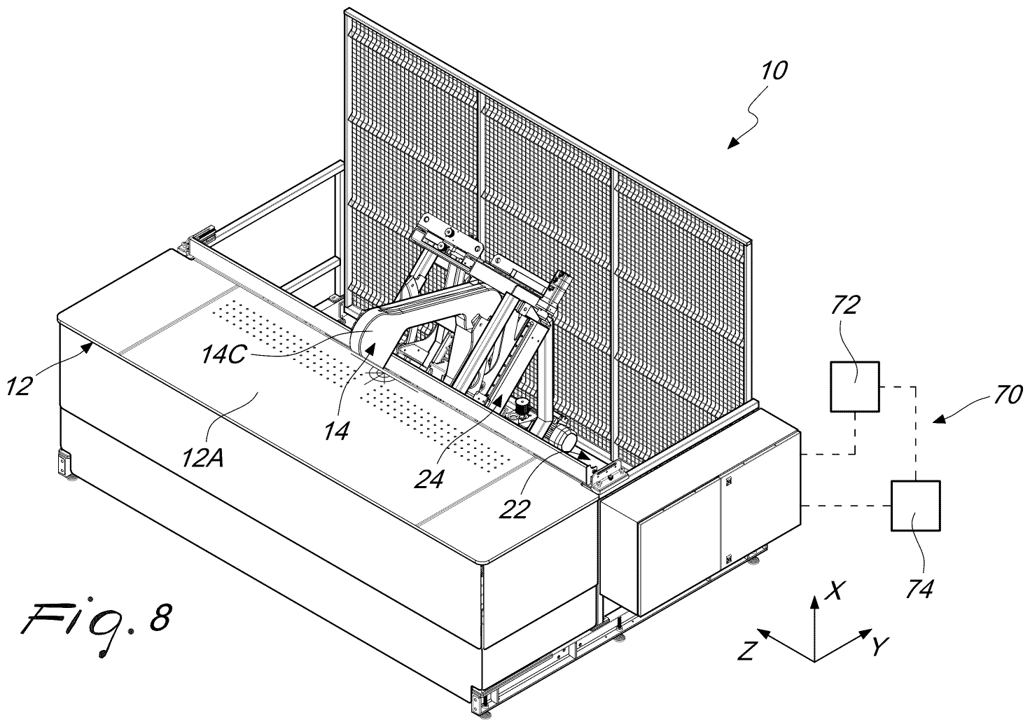

In some preferred aspects, the cutting apparatus 10 further comprises a guiding assembly 22 configured to guide the carrier member 14 along the cutting direction z1, z2 (see for example FIG. 8).

In the preferred and illustrated aspects, the guiding assembly 22 comprises a pair of rails 22A, 22B that extend parallel to the worktable 12 along the cutting direction z1, z2.

In particular, the cutting apparatus 10 comprises a bridge-like structure 24, which supports the carrier member 14, and the bridge-like structure 24 is configured to slide along the rails 22A and 22B (see for example FIG. 7).

Preferably, the bridge-like structure 24 comprises a lower bridge 24A and an upper bridge 24B, which can slide with respect to the lower bridge 24A.

In the preferred and illustrated aspects, the lower bridge 24A comprises a (fixed) circular guide 24A1 and the upper bridge 24B is configured to slide with respect to the circular guide 24A1 (see for example FIGS. 2 to 5). This sliding movement can be provided by means of a suitable system of wheels or sliders (not shown).

In practice, in the illustrated preferred aspects, the upper bridge 24B and the lower bridge 24A provide a slotted-link kinematic system.

Moreover, the upper bridge 24B is integral with the carrier member 14. Consequently, when the upper bridge 24B moves, the carrier member 14 moves in accordance with the movement of the upper bridge 24B.

In practice, in FIG. 4 the variation Δθ can be obtained by sliding the upper bridge 24B with respect to the circular guide 24A1.

Preferably, the circular guide 24A1 is shaped like a circular arc that has the axis of rotation 30 as its center.

In practice, when the upper bridge 24B slides with respect to the circular guide 24A1, said upper bridge 24B tilts, dragging the carrier member 14 with it, and the axis of rotation 30 coincides with an axis of instantaneous rotation of the upper bridge 24B. Consequently, the circular guide 24A1 and the upper bridge 24B allow to rotate the carrier member 14 precisely.

In some preferred aspects, the cutting apparatus 10 further comprises an adjustment device 70 (see for example FIGS. 6 and 8).

The adjustment device 70 is configured to receive cutting parameters related to the block 90 to be cut.

Moreover, the adjustment device 70 is configured to adjust at least one (preferably, all) of the inclination angle θ, the axial position w and the distance x automatically, on the basis of said cutting parameters.

In the preferred and illustrated aspects, the adjustment device 70 comprises an input periphery 72 and an electronic control unit (i.e., an actuation control unit) 74 (see for example FIGS. 6 and 8).

The input periphery 72 is configured to set said cutting parameters (i.e., cutting parameters related to the block 90 to be cut).

In particular, the cutting parameters are selected from the following parameters Bw, Hw, b, f, φ, Le, where:
Bw and Hw have already been discussed above (see for example FIG. 9);
b represents the height of the scrap 90B (i.e., the height of the portion of material to be removed from the block 90) (see for example FIG. 10);
f represents the width of the scrap 90B (see for example FIGS. 9 and 10);
φ, known as “complementary cutting angle” or “bevel angle” of the block 90, represents the inclination of the cutting axis 18 (and/or of the cutting tool 16) with respect to a vertical reference axis (see, for example, FIGS. 1 and 9); and
Le, known as “effective length”, represents the length of an effective portion 17, where “effective portion” means a part of the cutting axis 18 (and/or of the cutting tool 16) designed to intersect the block 90 during the cutting operation of said block 90 (see for example FIGS. 9, 10 and 11).

In other words, the effective length Le represents a mark that the cutting axis 18 (or, more generally, the respective cutting plane γ) is designed to leave on the block 90 when cutting said block 90.

Preferably, the width f is measured parallel to the length of the base Bw.

In particularly preferred aspects, the cutting parameters are the height Hw, the height b and the width f. However, alternative aspects are also conceivable in which the cutting parameters are different from Hw, b and f. In fact, the parameters Bw, Hw, b, f, φ and Le are related to each other by trigonometric relationships of a known type or, in any case, by geometric relationships that can be directly and unequivocally derived from the cited figures. By way of example, the value of b can be calculated as the difference between Hw and x. As a further example, the value of the complementary cutting angle φ can be calculated as the arctangent of the ratio between f and b. Or moreover, the value of Le can be calculated as the square root of the sum of the square of b and the square of f.

The input periphery 72 (FIGS. 6 and 8) can be implemented in various ways, for example by means of a keyboard or a touch screen where the operator can enter (manually) the cutting parameters.

Preferably, the input periphery 72 is integral with the cutting apparatus 10. However, more advanced aspects are also conceivable, in which the input periphery 72 is implemented in a separate electronic device (such as, for example, a PC, a tablet or a smartphone, in wired or wireless connection with the electronic control unit 74).

The electronic control unit 74 (i.e., an actuation control unit) is configured to vary one or more (and, preferably, all) of the inclination angle θ, the axial position w and the distance x, based on said cutting parameters.

In practice, the electronic control unit 74 is functionally connected to the input periphery 72 (see for example FIGS. 6 and 8).

In some preferred aspects, the adjustment device 70 (in particular, the actuation control unit 74) is configured to vary the axial position w (i.e., the position of the carrier member 14 along the cutting axis 18) so as to separate the carrier member 14 from the block 90 according to a preset clearance k.

In this way, the adjustment device 70 allows the carrier member 14 to be arranged in an optimal cutting position in order to minimize exposure of the cutting tool 16 while the block 90 is being cut.

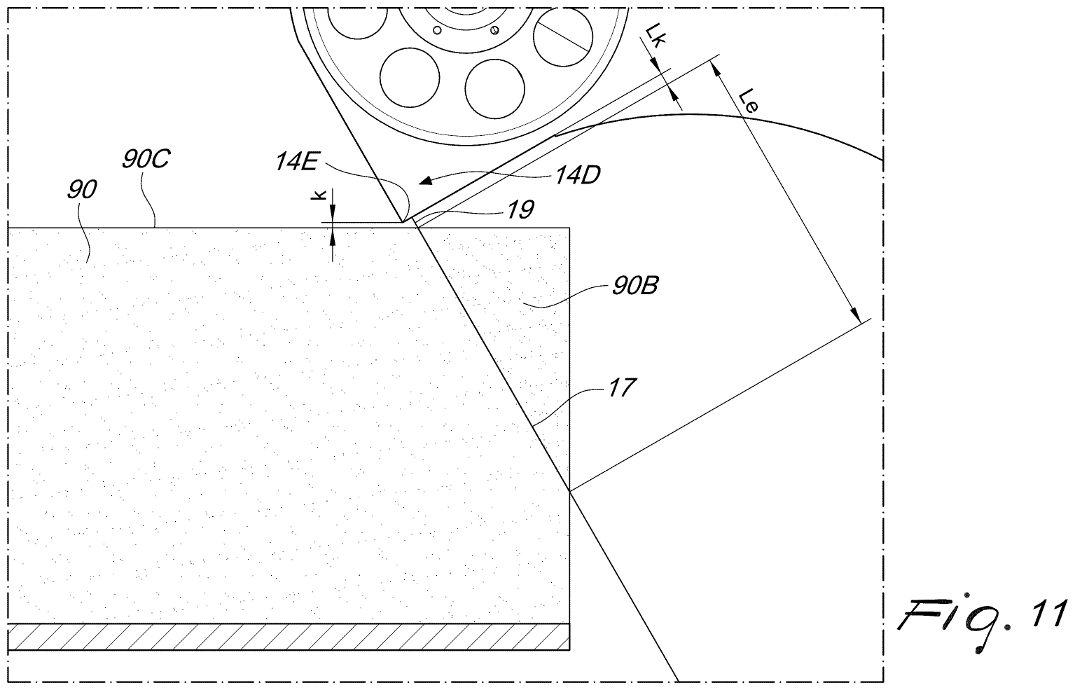

In practice, the preset clearance k expresses a minimum (non-zero) distance between a specific surface 90C of the block 90 to be cut and an end portion 14D (of the carrier member 14) that faces this specific surface 90C (see for example FIG. 11).

In the preferred and illustrated aspects, the surface 90C is an upper surface of the block 90, while the end portion 14D is a portion of the carrier member 14 that comprises a lower end 14E of the carrier member 14 (see for example FIG. 11).

In practice, the lower end 14E is designed to face the block 90 to be cut.

For example, in FIG. 11 the lower end 14E is a vertex (an edge) of the first arm 14 pointing towards the upper surface 90C. In other words, the lower end 14E is part of the outer casing 14C.

In practice, the presence of the preset clearance k prevents any collision between the outer casing 14C and the surface 90C of the block 90.

Advantageously, the preset clearance k can be dimensioned to prevent the passage of an operator's hand in the space that separates the outer casing 14C from said upper surface 90C. In this way, during the cutting of the block 90 the risk of contacts between the cutting tool 16 and the operator's hand is reduced significantly.

Preferably, the preset clearance k is comprised between 3 and 5 mm. Even more preferably, the preset clearance k is 4 mm. In this way, such risk is minimized while avoiding any collision between the outer casing 14C and the surface 90C.

In particularly advantageous preferred aspects, the adjustment device 70 (in particular, the actuation control unit 74) is configured to vary the axial position w of the carrier member 14 so as to minimize the length Lk of an excess portion 19 of the cutting axis 18 (and/or of the cutting tool 16) (see for example FIG. 11).

In practice, the excess portion 19 corresponds to a portion of the cutting axis 18 (and/or of the cutting tool 16) that is designed to remain exposed even when cutting the block 90.

In the preferred and illustrated aspects, the excess portion 19 corresponds to the part of the cutting tool 16 that by protruding from the end portion 14D (i.e., the first end portion 14A), extends between this specific portion of the carrier member and the upper surface 90C of the block 90 (see for example FIG. 11). In practice, during the cutting of the block 90, the presence of the preset clearance k prevents the operator from coming into contact with the excess portion 19.

In particularly advantageous preferred aspects, the adjustment device 70 (in particular: the actuation control unit 74 visible in FIGS. 6 and 8) is configured to adjust the length Lk (in particular, reducing this latter length) on the basis of preset design parameters.

In practice, the design parameters are set during the installation of the cutting apparatus 10, for example by means of the input periphery 72.

Preferably, the design parameters comprise (or correspond to) the preset clearance k and a protrusion length i.

In particular, the protrusion length i expresses a maximum transverse space occupation of the end portion 14D.

In practice, the protrusion length i corresponds to a machine footprint parameter.

In the preferred and illustrated aspects, the protrusion length i expresses a maximum distance (measured at right angles to the cutting axis 18) between the cutting axis 18 and a plane δ (which is parallel to the cutting axis 18) on which the lower end 14E lies. In other words, the protrusion length i indicates the distance between the planes γ and δ (see for example FIG. 10).

In practice, the adjustment device 70 is configured to calculate the length Lk as a function of two parameters (k and i) that take into account the space occupation of the outer casing 14C, in order to prevent any collision between the outer casing 14C and the upper surface 90C.

For example, the adjustment device 70 (in particular, the actuation control unit 74) can be configured to vary the axial position w (of the carrier member 14) based on a method comprising the steps m1, m2 and m3 discussed hereinafter.

In step m1, the effective length Le is calculated based on the parameters f and b (which, as mentioned, represent the width and height of the scrap 90B, respectively).

In step m2, the length Lk (i.e., the length of the excess portion 19) is calculated according to the parameter f, the angle of inclination θ, and the protrusion length i. In practice, in step m2 the length Lk is calculated so as to prevent any unwanted interpenetration between the carrier member 14 and the block 90.

In step m3, the carrier member 14 is translated along the cutting axis 18, so as to leave exposed a (specific) portion of the cutting tool 16. This (specific) exposed portion has a length equal to the sum of the effective length Le (calculated in step m1) and the length Lk (calculated in step m2).

In the preferred and illustrated aspects, the portion of the cutting tool 16 that is left exposed during step m3 is formed by the union of the effective portion 17 and the excess portion 19 (see for example FIGS. 9 and 11).

In practice, in step m3 the carrier member 14 is moved (forward or backward) along the cutting axis 18, so as to minimize the exposure of the cutting tool 16 during the cutting of the block 90.

Consequently, steps m1 to m3 ensure that during the cutting of the block 90 the only portion of the cutting tool to which the operator is potentially exposed is the excess portion 19.

For example, when steps m1 and/or m2 are performed while the cutting tool 16 is in a position of maximum exposure (that is, in an operating position in which the cutting tool 16 is completely visible to the operator), step m3 may consist in moving back the cutting tool 16 along the cutting axis 18 by an amount Q calculated as follows:

$$Q = Lu - Lk - Le$$

where:
“Lu” identifies the so-called “useful length” of the cutting axis 18 (i.e., the maximum length of a portion of the cutting axis that can be used to perform a linear cut like the ones described above);
“Lk” is the length (of the excess portion 19) calculated in step m2; and
“Le” is the effective length calculated in step m1.

In the preferred and illustrated aspects, the useful length Lu identifies a portion of the cutting axis 18 (and/or of the cutting tool 16) that extends between the first end portion 14A and the second end portion 14B (see for example FIGS. 1 and 9).

In practice, the quantity Q expresses the length of a portion of the cutting tool 18 that is designed to remain hidden while cutting the block 90.

In any case, the sequence of steps m1 to m3 can also be performed starting from a condition in which the cutting tool 16 is in an operating position other than the maximum exposure position (for example: due to a previous cut on another block). In other words, during steps m1 and/or m2, the cutting tool 16 can also be in an intermediate operating position, comprised between a minimum exposure position (in which the cutting tool 16 is completely hidden from the operator) and the maximum exposure position.

In practice, the adjustment device 70 is configured to minimize the length Lk regardless of the starting position of the cutting tool 16, on the basis of appropriate cutting and machine footprint parameters.

In the aspects in which the cutting tool 16 is a blade, the maximum exposure position corresponds to a condition of use in which the blade is fully exposed; conversely, the minimum exposure position corresponds to a condition of use in which the blade is fully concealed.

In practice, in the aspects that comprise the input periphery 72 and the actuation control unit 74 (see for example FIGS. 6 and 8), the entry of specific cutting parameters in the input periphery 72 allows to define the geometry of the cut (or bevel) to be provided. These specific cutting parameters are then processed by the actuation control unit 74, which arranges the carrier member 14 according to an optimal cutting configuration for performing a desired cut. Consequently, an input periphery and an actuation control unit such as those described above result in an automatic adjustment device that allows the cutting axis 18 to be optimally positioned to cut the block 90 according to a desired cutting profile starting from the (manual) entry of simple cutting parameters.

Advantageously, it is possible to configure the desired cutting configuration by entering just three cutting parameters, i.e., the height Hw and the cutting parameters b and f.

The operation of the cutting apparatus 10 is clear and evident from what has been described.

Essentially, the carrier member 14 tilts according to the cut (or bevel) to be provided on the block 90 (see for example FIG. 4); moreover, the carrier member 14 translates along the cutting axis 18 (in particular, moving backwards on the linear guide 26, for example in the manner shown by FIG. 3), in order to minimize the protrusion of the excess portion 19. Consequently, the translation of the carrier member 14 along the cutting axis 18 allows to leave exposed, with respect to the worktable 12, only that portion of the cutting tool that is strictly necessary to obtain the desired cutting geometry, increasing the operator's safety during the cutting of the block 90.

The cutting apparatus 10 can be designed with interchangeable blocks, so as to obtain a modular structure conceived to adapt to the various production requirements.

In particular, the worktable 12, the carrier member 14 and the carriage 24 can be assembled according to a plurality of mutually different configurations, appropriately designed as a function of a specific processing system in which the cutting apparatus 10 is intended to be integrated.

For example, the cutting apparatus 10 can be part of an in-line or island processing system of the automatic, semi-automatic or manual type, etc.

It has been found that the present disclosure fully achieves the intended aims and objects. In particular, it has been shown that the cutting apparatus thus conceived allows to exceed the qualitative limits of the background art, since the combination of its three adjustment movements allows a wide range of cutting geometries to be utilized, from bevels of different sizes and types to flat sheets of various thicknesses.

Although the cutting apparatus according to the disclosure has been conceived to cut blocks of polymeric material, it can be used anyway more generally to cut other types of material.

The disclosure thus conceived is susceptible of numerous modifications and variations, all of which are within the scope of the accompanying claims.

Unless otherwise specified, the various aspects described above can be combined to provide further and/or alternative aspects. In addition, the present description covers combinations of preferred aspects and variants not explicitly described.

All the details may furthermore be replaced with other technically equivalent elements.

In practice, the materials used, so long as they are compatible with the specific use, as well as the contingent shapes and dimensions, may be any according to the requirements and the state of the art.

To conclude, the scope of the protection of the claims must not be limited by the illustrations or preferred aspects shown in the description by way of example, but rather the claims must comprise all the characteristics of patentable novelty that reside in the present disclosure, including all the characteristics that would be treated as equivalents by the person skilled in the art.

What is claimed is:

1. A cutting apparatus for performing linear cuts of oblique or vertical type at least on a block of polymeric material, said cutting apparatus comprising:
a worktable, adapted to support the block to be cut; and
a carrier member, configured to carry a cutting tool designed to cut said block, said carrier member defining a cutting axis for said cutting tool, said carrier member being designed so that, when said carrier member carries said cutting tool, at least part of said cutting tool extends along said cutting axis,
wherein
said carrier member is configured to be tilted with respect to said worktable, so as to vary an angle of inclination of said cutting axis with respect to said worktable,
said carrier member is translatable along said cutting axis, so as to vary an axial position of said carrier member along said cutting axis,
at least one of said worktable and said carrier member is movable along a movement direction which is arranged angularly with respect to said cutting axis, so as to vary a distance between said worktable and said cutting axis along said movement direction, and
at least one of said worktable and said carrier member is movable along a cutting direction perpendicular to both said cutting axis and said movement direction, in order to cut said block along a cutting plane on which said cutting axis lies.

2. The cutting apparatus according to claim 1, wherein said worktable is movable with respect to said carrier member along said movement direction.

3. The cutting apparatus according to claim 1, wherein said carrier member is movable with respect to said worktable along said cutting direction.

4. The cutting apparatus according to claim 1, further comprising an adjustment device configured to:
receive cutting parameters related to the block to be cut; and
adjust at least one of said angle of inclination, said axial position and said distance automatically, based on said cutting parameters.

5. The cutting apparatus according to claim 4, wherein said cutting parameters comprise the parameters b, f, Hw, and wherein:
parameter b comprises a height of a portion of material to be removed from said block;
parameter f comprises a width of said portion of material to be removed from said block; and
parameter Hw comprises a height of said block.

6. The cutting apparatus according to claim 5, wherein said adjustment device is configured to vary said axial position so as to separate said carrier member from said block in accordance with a preset clearance.

7. The cutting apparatus according to claim 6, wherein said preset clearance is from 3 to 5 mm.

8. The cutting apparatus according to claim 4, wherein said adjustment device is configured to vary said axial position so as to minimize a length of an excess portion of said cutting axis.

9. The cutting apparatus according to claim 8, wherein said adjustment device is configured to adjust the length of said excess portion based on preset design parameters, said preset design parameters comprising:
said preset clearance; and
a protrusion length, said protrusion length expressing a maximum distance between said cutting axis and a plane on which a lower end of said carrier member lies, said lower end being designed to face the block to be cut.

10. The cutting apparatus according to claim 6, wherein said adjustment device is configured to vary said axial position on the basis of a method comprising steps m1, m2 and m3, wherein:
step m1 comprises calculating an effective length of said cutting axis based on said parameter f and said parameter b;
step m2 comprises calculating the length of said excess portion based on said parameter f, said angle of inclination, and said protrusion length; and
step m3 comprises translating said carrier member along said cutting axis, so as to leave a portion of said cutting tool exposed, said exposed portion of said cutting tool having a length equal to the sum of (1) the effective length calculated in step m1, and (2) the length of said excess portion calculated in step m2.

11. The cutting apparatus according to claim 1, wherein the polymeric material is polyurethane foam.
